(19) United States
(12) Patent Application Publication
(10) Pub. No.: US 2026/0004103 A1
(43) Pub. Date: Jan. 1, 2026

(54) PRE-TRAINED LARGE INFORMATION TECHNOLOGY HOLISTIC INFRASTRUCTURE UBIQUITOUS MODELS

(71) Applicant: Dell Products L.P., Round Rock, TX (US)

(72) Inventors: Werner Spolidoro Freund, Rio de Janeiro (BR); Sarah Evans, Parker, CO (US); David Burth Kurka, Campinas (BR)

(21) Appl. No.: 18/761,181

(22) Filed: Jul. 1, 2024

(51) Int. Cl. G06N 3/042; G06N 3/0895

(52) U.S. Cl. CPC G06N 3/042; G06N 3/0895

(57) ABSTRACT

One example method is for constructing and pre-training a model of an information technology (IT) infrastructure, and includes creating a model of the IT infrastructure by, generating a KG (knowledge graph) representation of IT infrastructure data, serializing information flows within the KG to generate serialized information flows, and pre-processing the serialized information flows to improve a quality of the IT infrastructure data relative to a quality of the IT infrastructure data prior to the pre-processing, and pre-training the model, including training the model to capture a structure of both natural language and IT infrastructure flow by predicting, without hallucinations, tokens and identities of the IT infrastructure, providing customizations to enable the model to correctly predict the identities, and pre-training the model with causal modeling when identities are unknown in one of the information flows.

### TECHNOLOGICAL FIELD OF THE DISCLOSURE

Embodiments disclosed herein generally relate to IT (information technology) infrastructure models. More particularly, at least some embodiments relate to systems, hardware, software, computer-readable media, and methods, for modeling IT infrastructures to create infrastructure models that encapsulate both natural language and machine readable IT information. An infrastructure model may be used for various purposes, such as, but not limited to, predicting and/or identifying particular behavior in an IT infrastructure, resolving a problem with the IT infrastructure and/or its processes, and enabling improvements to the structure and/or operation of the IT infrastructure, such as with respect to cybersecurity for example.

### BACKGROUND

The DoD Zero Trust Reference Architecture (ZTRA) (see reference [1] below) defines several postures to increase network cybersecurity inspired by Zero Trust (ZT) tenets and principles. Achieving the most mature levels of defensive postures typically requires heavy usage of statistical learning, inference, and automation, to provide a scalable approach.

The so-called Bitter Lesson (see reference [2] below) is an Artificial Intelligence (AI) research insight. It states that, when considering longer term AI developments, one should focus on general methods that leverage computation, instead of human knowledge of a problem. The general-purpose approach is characterized by the aspect of continuous scaling with increased computation even as the available computation greatly increases. The success of generative AI is the latest effective example of such insight. Generative AI, in this context, refers to scalable neural models, such as transformers and other variations, trained upon large data corpora to predict a structured sequence of variable size.

However, the development of general-purpose approaches is limited to most common AI data modalities such as textual, visual and audio sources. Cybersecurity, for example, is a field mostly driven by subject matter expertise and this pattern holds true in the ZTRA path for defensive postures based on AI developments leveraging human expertise. Entities may have an opportunity to benefit from the Bitter Lesson insights in an innovative application of AI in ZTRA for statistical learning, inference, and automation.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an example of information serialization and encoding in embedding space for tokens, according to one embodiment.

FIG. 2 discloses aspects of an example information flow capillarization method, according to one embodiment.

FIG. 3 discloses aspects of an example method to predict novel activities in the network with correct identities when performing auto-regressive pre-training, according to one embodiment.

FIG. 4 discloses a computing entity configured and operable to perform any of the disclosed methods, processes, and operations.

### DETAILED DESCRIPTION OF SOME EXAMPLE EMBODIMENTS

Embodiments disclosed herein generally relate to IT (information technology) infrastructure models. More particularly, at least some embodiments relate to systems, hardware, software, computer-readable media, and methods, for modeling IT infrastructures to create infrastructure models that encapsulate both natural language and machine readable IT information. An infrastructure model may be used for various purposes, such as, but not limited to, predicting and/or identifying particular behavior in an IT infrastructure, resolving a problem with the IT infrastructure and/or its processes, and enabling improvements to the structure and/or operation of the IT infrastructure, such as with respect to cybersecurity for example.

One example embodiment comprises a method for modeling an IT infrastructure, so as to generate a pre-trained model. As disclosed herein, the model obtained by such a method may be used for a variety of purposes, none of which should be construed as limiting the scope of this disclosure or any claims presented at any time in this application. Such purposes may include, but are not limited to, troubleshooting, modifications to IT infrastructure hardware and/or software so as to improve performance of the IT infrastructure, and evaluation of potential changes to an IT infrastructure by implementing what-if structural and operational scenarios in a model, and/or using a model to evaluate various what-if scenarios.

In one embodiment, such a method may be used to create a pre-trained LITHIUM (Large Information Technology Holistic Infrastructure Ubiquitous Model). In one embodiment, a method to create such a LITHIUM model may comprise the following operations: generating a Knowledge Graph (KG) representation of the IT infrastructure data; serializing the information flows within the KG are serialized using a process similar to tokenization, and including modifications to address one or more of the challenges disclosed herein, where the modifications include: (1) adding, in addition to a token embedding space, an identity space to ensure that identities are not memorized by the model, so as to prevent information leakage between IT systems; (2) using an intrinsic Retrieval Augmented Generation (RAG) mechanism to populate implicit context within the IT infrastructure not present in the information flow; (3) using a representation of an information flow tempos to capture the IT system structure in this space; and (4) adding descriptions of the join and merge processes occurring in the IT infrastructure information to enable information flow capillarization representation; pre-processing the resulting information flows to improve training data quality—techniques similar to LLMs (large language models) data pre-processing may be adapted to IT infrastructure information flows; and performing a pre-training process that may comprise: (1) training the model to capture the structure of both natural language and network information flow by predicting tokens in strategies akin to LLMs self-supervised training; (2) providing customizations to enable the model to predict identities correctly; and (3) pre-train the model with causal modelling when identities are unknown in the information flow.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a model may be created that captures IT infrastructure data structure and provide a general-purpose approach that encapsulates both natural language and machine readable IT information. An embodiment may create, and use, a model that transcends common data modalities such as text, visual, and audio, sources typically used in generative AI approaches, and extends to the use of AI in a ZTRA for statistical learning, inference, and automation, with respect to the structure and operation of the ZTRA. Various other advantages of one or more example embodiments will be apparent from this disclosure.

### A. References

Following is a list of references that may be referred to herein. These are all incorporated herein in their respective entireties by this reference.
[1] DISA and NSA, 2022. Department of Defense Zero Trust Reference Architecture, Version 2.0.
[2]R. Sutton, “The Bitter Lesson.” 2019. [Online]. Available: https://www.cs.utexas.edu/˜eunsol/courses/data/bitter_lesson.pdf
[3]Y. Sun et al., “ERNIE 3.0: Large-scale Knowledge Enhanced Pre-training for Language Understanding and Generation.” arXiv, Jul. 5, 2021. doi: 10.48550/arXiv.2107.02137.
[4]J. Devlin, M.-W. Chang, K. Lee, and K. Toutanova, “BERT: Pre-training of Deep Bidirectional Transformersfor Language Understanding.” arXiv, May 24, 2019. Accessed: Sep. 27, 2022. [Online]. Available: http://arxiv.org/abs/1810.04805.

### B. Context for an Example Embodiment

One example embodiment may address the problem of providing a general-purpose approach to model IT infrastructure data that is aligned with the learnings of the Bitter Lesson by adapting state-of-the-art generative AI solutions. An approach according to one embodiment is inspired by natural language modelling, in which both IT infrastructure and natural language data concern information flow. As discussed in the sections immediately below however, there are various challenges specific to IT infrastructure data, and any one or more of these may be addressed by an embodiment that is directed to building an approach, and model, that are able to process such IT infrastructure data.

### B.1 Information Capillarization

One aspect of an embodiment concerns so-called information capillarization. Particularly, natural language is composed of a continuous sequence of information. IT infrastructure data flows, however, are not a straight-forward continuous sequence. Rather, IT infrastructure data typically starts as single channel and may split and merge inadvertently with other information flows in the technology stack. For example, identity data may merge with device data and network data to form a new meaningful IT infrastructure data flows.

### B.2 Information Flow Tempo

Written natural language enables the reader to determine the speed of information flow. However, in general-purpose IT infrastructure approaches, data travels at various flow speeds, or tempos. Such data may include, for example, event message queues, periodic batch refreshes, and other methods in which accounts log in and out of applications and make information requests. The IT infrastructure flow tempos play an important role in the IT infrastructure architecture and system designs to improve or constrain downstream events.

### B.3 Implicit Context

In natural language, communication is optimized to allow understanding based on contextual information assumptions. For example, for the phrase “I see” can mean that something is seen, or that phrase may be used to say that something is understood.

On the other hand, an embodiment may assume that network information flow is much more dependent on infrastructure context not expressed in the communication channels to be correctly defined. This context may be provided by the details of entities participating in the information flow. This assumption is aligned with a ZT tenet that decision making is to be performed considering contextual variables. An example of this is impossible travel.

In particular, if a user logs in in North America, and five minutes later, logs in again from Europe, the context that this is impossible travel must be defined for the system to observe and take some associated action when it is observed. Without the system being informed about impossible travel and how to observe it, the context of the two back-to-back logins from two very different locations would not be inherently understood, or understandable, by the IT infrastructure.

### B.4 Universal Semantics

IT infrastructure information flow is a mix of both machine operations, and natural language, that is, all IT communication is developed or employed to serve humans in some sort of way. As such, a universal framework capable of capturing the structure of both information flows, that is, the information flow regarding machine operations and the natural language information flow, may be required. It is noted that the ability to understand natural language semantics, while manipulating IT infrastructure information flow, can be a powerful tool to enhance generalization by, in one embodiment, enabling a model to decode the intent of machine operations, and therefore capture similarities between operations even if such similarities were not available or apparent via natural language inputs in the training dataset.

### B.5 Frivolous Information

IT infrastructure information flow is more susceptible to the observation of frivolous information and repetition than natural language. This is because what is being observed are internal network states in machine language, versus an output in natural language. As an example, a verbose event log is generated by the IT infrastructure, but likely does not have immediate natural language meaning to a human reader. Thus, a modelling approach according to one embodiment is able to determine the level of details in which it describes information flow. This is not required in natural language because this process is already typically performed within the human mind and data is already collected with what is most relevant for the communication goals.

### B.6 Hallucination

LLMs have been known to hallucinate, that is, they may respond to prompts with information that is not true, but which the LLM has suggested might be true based on the data on which it was trained. In the case of IT infrastructures, hallucination of IT data, such as an identity, that is not true but that the LLM suggests is, may be a concern when leveraging similar technology.

### C. Overview of Aspects of One Embodiment

### C.1 Introduction

There are existing approaches that unify LLMs and KGs. KG-enhanced pre-training is also available, that provide potential integration paths of information flows and IT infrastructure context. These technologies, however, only operate with relevant knowledge sub-graph inputs of tokenized textual information, and do not consider IT data or how to obtain a serialization from it.

In the cybersecurity domain, for example, there are also available approaches based on KG and neural modeling of IT infrastructure data. Such approaches, however, focus on particular modalities of IT information, such as network, provenance graphs, and other particular analytics tasks. By way of contrast, a model according to one embodiment may model information flow, and the context where that information flow is occurring, without requiring subject matter experts to stitch together fragmented, siloed, lenses of the problem technology stack.

An embodiment may accommodate heterogeneous sources such as, for example, OS (operating system), network, monolith, and microservice-based applications. A Knowledge Graph (KG) provides a flexible database that can efficiently consume irregular and arbitrary data points. While data can be stored in various databases and integrated through various approaches including different backends, an embodiment may represent telemetry through a KG for simplicity of exposition.

Informally, a KG is a conceptual information representation of a set fact, namely, in one embodiment, the network activity, and its attributes. In an embodiment, a KG may be built upon many existing storages, such as relational databases, graph databases, and triple stores. An embodiment may employ a KG, as discussed below, using a triple store. However, the scope of this disclosure and the claims is not limited to the example triple store implementation of a KG.

In more detail, in a triple store, each telemetry point is eventually transformed to a set of tuples in the format (s,p,o) which may be referred to as a “triple,” where, in the tuple, s stands for subject, o for object, and p for predicate. Thus, for example, an activity representing the information flow of a request of a ‘user U’ aiming to ‘access’ an ‘application A’ may be registered as the tuple of triples [(U,is_a,User), (A,is_a,Application), (U,access,A)], readable as “a user U accesses an application A.” Likewise, contextual variables of the information flow can also be represented to capture relevant aspects of where and how the information flow is happening. For instance, an application hygiene record may be represented as triples thus [(A,has_/lib,L₁), (L₁,version,(3,4, 1))].

### C.2 Aspects of an Example Embodiment

In an embodiment, IT infrastructure data should be captured with as much relevant detail as possible and made available in an integrated way. In one embodiment, the IT infrastructure data collected may include, but is not limited to, architecture, event, observability, tracing logs, control point policies and business logic, and ecosystem partner data lake repositories. One example embodiment comprises a method to generate value from such data. One embodiment may comprise general purpose solution to IT infrastructure data that enables the Bitter Lesson to be addressed when using AI in the IT space allow. For example, an embodiment may capture the problem space structure and enabling performance of downstream tasks with few samples, using generative AI for example. One embodiment may be referred to herein as LITHIUM (Large Information Technology Holistic Infrastructure Ubiquitous Models), by way of contrast with LLMs (Large Language Models).

In one embodiment, a pre-trained LITHIUM model may be constructed using the following operations:
(1) a Knowledge Graph (KG) representation of the IT infrastructure data is generated;
(2) the information flows within the KG are serialized through a process similar to tokenization, but with modifications that handle the challenges described earlier herein:
   (a) beyond the token embedding space, an identity space is added to ensure that identities are not memorized by the model—this may prevent information leakage between IT systems;
   (b) an intrinsic Retrieval Augmented Generation (RAG) mechanism populates implicit context within the IT infrastructure not present in the information flow;
   (c) a representation of information flow tempos is used to capture the structure in this space; and
   (d) descriptions of the join and merge processes occurring in the IT infrastructure information flow are added, which allows information flow capillarization representation;
(3) pre-process the resulting information flows to improve training data quality—here, techniques similar to LLMs data pre-processing may be adapted to IT infrastructure information flows; and
(4) Pre-train:
   (a) train the model to capture the structure of both natural language and network information flow by predicting tokens in strategies akin to LLMs self-supervised training;
   (b) provide customizations to allow the model to predict identities correctly; and
   (c) pre-train with causal modelling when identities are unknown in the information flow.

This example implementation of LITHIUM technology may be employed in various use cases, as is the case with LLMs. In the simplest scenario, one embodiment of a model may be used to perform downstream, that is, after model development and training, tasks such as cybersecurity analytics and automation as defined in ZTAs or to improve IT infrastructure performance.

### C.3 Further Discussion

An aspect of one embodiment is the ability to implement, and use, LITHIUM Artificial Intelligence (AI) to capture IT infrastructure data structure. An embodiment may comprise a general-purpose approach that encapsulates both natural language IT information, and machine readable IT information. Other aspects of one or more embodiment are set forth below.

For example, an embodiment may implement, and use, a data serialization framework that possesses any one or more of the following functionalities: capable of representing both natural language and IT infrastructure information flows and sharing common factors of variation—a property that may be referred to herein as ‘universal semantics’—this may be achieved through Knowledge Graph tokenization; able to discriminate between information sources to facilitate disambiguating semantics whenever required—to this end, an embodiment may employ a dedicated segment embedding space; provides a mechanism to avoid memorization of architecture specific identities—in an embodiment, this may be achieved through a randomized identity embedding space; can represent the structure information flow tempo, without losing precision, in a large dynamic range; possesses a general-purpose retrieval augmented generation mechanism to describe the problem space during training and inference time with IT infrastructure specificities on demand—as such, an embodiment may provide access to implicit context, that is, information not available in the activities themselves; can handle information flow in variable number of channels, a process that may be referred to herein as ‘information flow capillarization’—in an embodiment, this may be achieved by modifying the serialization process to improve data quality; and can benefit from improved data quality through mechanisms adapted from natural language literature, such as deduplication at various granularity levels.

One embodiment may build on concepts in current state-of-the-art generative AI (gAI) modelling approaches. In one embodiment, current state gAI approaches are adapted to the IT problem space and may comprise the following aspects: it is IT infrastructure agnostic when considering entity identities—in an embodiment, a model precisely determines identities, even for novel IT infrastructures—this may be achieved through the addition of an identity identifier that is employed instead of the token identifier when identity is required, and the identity is ensured to be valid and determined based on the IT infrastructure description; an embodiment may benefit from all pre-training mechanisms currently employed for gAI modelling of natural language; and an embodiment may leverage autoregressive pre-training which generates activities that require correctly identifying entities not present in the information flow but that are valid in the architecture—thus, a general approach captured in one embodiment may be able to be employed by both ‘red’ and ‘blue’ teams, that is, respectively, teams that attempt to attack the cybersecurity defenses of an entity, and teams that attempt to defend against, and respond to, such attacks.

### D. Detailed Discussion of Aspects of One Embodiment

One embodiment deals with the challenge of deriving a general-purpose solution, that is, a solution that is compliant with Bitter Lesson AI insights, for IT infrastructure data. The development of a general-purpose approach such as this requires looking to the problem through a different perspective. Instead of driving modeling of IT data focused on maximizing efficiency considering computation power as a fixed constraint, an approach according to one embodiment may be performed to ensure its scalability as a function of computation power even when it eventually increases and becomes very large. Therefore, an embodiment may efficiently leverage computation power and massive amounts of properly obtained data to determine the result, that is, a computational model capable of capturing the structure of a problem space such as an IT infrastructure.

### D.1 Definitions

For the purposes of this disclosure, various concepts and mathematical notation involved in the general-purpose modelling of IT infrastructure data are defined as follows:
Prime network: informally, the prime network refers to all known entities and potential relationships that are, or may be, used to characterize information flow in an IT infrastructure.
   Therefore, differently to an IT expert view of a network, which is typically understood as communication between endpoints, the prime network provides a much richer set of entities and relationships. It is not limited to typical network boundaries.
   Example of potential entities in a prime network are its inventory, that is, infrastructure entities that may comprise hardware and/or software, configuration aspects, internal states of various types such as libraries, and status of code execution, users, non-human entities, processes, sockets, workload types, monolithic applications, and micro-service, for example.
   One embodiment to represent such arbitrary structure is based on KG technology. Let such a KG be denoted by [symbol] ₙₑₜ=( [symbol] ₙₑₜ, εₙₑₜ) and composed of a set of prime network entities vᵢϵ [symbol] ₙₑₜ and their relationships eₖ=(vᵢ,τ,vⱼ)ϵεₙₑₜ. The relationship e connects entities vᵢ, vⱼϵ [symbol] ₙₑₜ through an edge type τϵTₙₑₜ.
Information flow: the prime network is simply the description of an IT infrastructure. It is only valuable if information flow occurs as desired, therefore providing data access, storage, manipulation such as through computation, and communication capabilities in a cost-efficient and secure way. Below, the notation to describe information flow is expanded as follows:
   Let [symbol] denote an information flow that comprises a context [symbol] , a metadata set [symbol] , and a set of activities [symbol] .
   An activity has the quadruplet form aₖ=(sₖ, pₖ, oₖ, tₖ)ϵ [symbol] , which is a standard triplet accompanied of its timestamp. For maximum generalization, differently from [symbol] and [symbol] , an activity may be described using only identities of entities and relationships underlying the activity. Thus, sₖ, oₖ,pₖϵ [symbol] are identities. This constraint may be alleviated for pₖ in many cases when it is a straightforward semantic relationship that is never expected to contain additional information.
   Information Flow Context: the activity identities may not be enough to define the information flow in enough detail. Both external and internal prime network entities and their relationships in the information flow have properties and states that enrich the problem space and enable better definition of the problem space.
   Let [symbol] denote the context where the information flow is happening.
      It is composed of a set of information flow details [symbol] which are particular to the information flow, such as the information sent in a communication channel, such as a request or a response for example, or modification in prime network states, for example, system rebooting, and a library version. It can be used to accommodate any unstructured or temporary state that is not predicted as part of [symbol] .
      On the other hand, [symbol] is the subset of prime network entities and relationships related to the particular information flow. It is available for the model on demand whenever required, therefore, in one embodiment, it may not need to be predicted.
   Finally, the metadata set [symbol] enables enrichment of an information flow with any information that is relevant to the problem space not captured by the context set [symbol] . Therefore, it must be obtained by a mechanism other than simply obtaining the context of the assessed information flow. This can be formed by natural language description of what was its intent, a reference to other relevant information flows—for example, a previous information flow as performed by a primary entity. Obtaining this metadata may require, for instance, the implementation of a user interface to request description of the activities being performed. Such metadata may be relevant to allow automation to occur in IT infrastructure based on natural language description. Other metadata such as related information flows are expected to allow automation to be correctly performed even if the provided natural language description is very brief and lack enough context.
Information flow loop: is a subset of activities that start at an entity and eventually return to the same entity before continuing. Another pattern that is particular to prime network information flow when compared to natural language is the phenomenon referred to herein as ‘information capillarization.’
Primary entity: is the entity starting the information flow. An embodiment may a mechanism that is able to capture as many details from the primary entity as required. Examples of primary entity can be, but are not limited to, a (user, device) pair, or an external/internal non-human entity.
Core entities: the variety of internal entities in the prime network can be arbitrarily large. However, some entities are typically more relevant than others to determine the information flow. Typically, entities participating in decision making processes determining information flow control are expected to have more powerful contributions in predicting it then auxiliary or secondary entities. The primary entity is a core entity.

### D.2 Data Serialization

In connection with one embodiment, reference is made to data serialization as a process of transforming information flow to a sequence of information pieces. One embodiment may be based on a natural language serialization process, since IT infrastructure data often contains semantics expressed in human language. Additionally, automation through natural language specification requires a universal approach capable of parsing and understanding both prime network information flow and natural language. The mathematical framework described earlier herein may enable such specifications to occur through the information flow metadata set [symbol] .

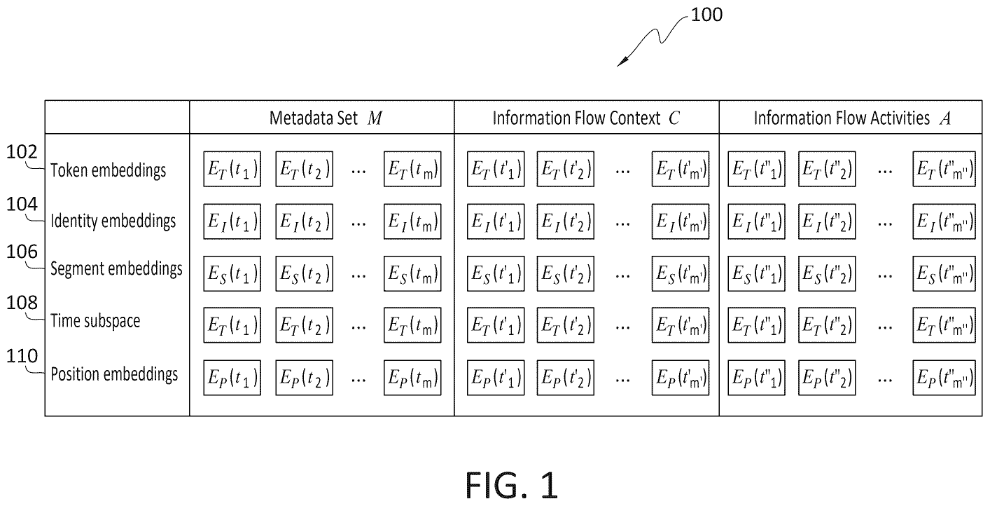

Turning now to FIG. 1, there is disclosed an implementation of information serialization and encoding in embedding space for tokens {t₁, . . . , tₘ}ϵ [symbol] ,

$$\{ {t}_{1}^{′} , … , {t}_{m ′}^{′} \} ∈ 𝒞$$

and {t₁″, . . . , t″_{m″}}ϵ [symbol] . Embedding subspaces have their own dimensionality and may be aggregated in a single space before being processed by the model or may be processed by their own modules as described below. That is, FIG. 1 discloses a serialization process 100 of the content in the information flow as described in the KG representation.

The approach disclosed in FIG. 1 results in the generation of 5 subspaces: token embeddings 102, identity embeddings 104, segment embeddings 106, time subspace embeddings 108 and position embeddings 110. As well, an embodiment may perform modifications to the token embedding subspace 102 to handle specificities of IT infrastructure data, as discussed above with respect to the challenges presented by information capillarization, information flow tempo, implicit context, universal semantics, and frivolous information.

### D.2.1 Implicit Context

For each activity in the information flow, there is explicit context observed in the activity itself such as the request and response contents. However, information flow context may benefit of much more context to what is present in the directly observed information flow, such as the states of entities participating in the flow or even general network states. These are available in a prime network representation and can be added to the serialization to improve problem space description. Thus, including such information provides a much more powerful general-purpose solution. Differently from natural language, an IT infrastructure model according to one embodiment may directly observe and obtain such information by performing activities in the prime network. Therefore, [symbol] is populated simply based on generated activities, in one embodiment.

### D.2.2 Knowledge Graph Tokenization

Prime network information flow has the benefit, in one embodiment, of being structured in a KG representation as described above. Instead of using standard GraphML technology, an embodiment may operate to serialize a prime network similarly to what is performed for natural language, that is, through tokenization.

### D.2.2.1 Universal Semantics

To handle the challenge of providing universal semantics for both natural language and machine communication, an embodiment may comprise a mechanism to efficiently encode both semantics in a single approach that enables sharing of statistical power between common factors of variation. For instance, an operation [READ] or a prime network entity [PROCESS] has similar semantics to the corresponding verb and noun in English.

Given an information flow [symbol] , an embodiment may handle this problem by tokenizing it in the following way:
Identity embeddings: Large language models (LLMs) do not have any particular mechanism to handle unique identities. They are parsed as text and generate tokens to be embedded in the same space. This makes modelling of identities more complex than it needs to be. The model may be required to combine several tokens in order to recognize it or infer it through semantics of other tokens in the sentence.
   An embodiment may overcome this limitation by adding an additional n_{id} dimensional space that is only to be populated by information flow identities; and
   let gen_id_embedding(⋅) be a special function that project identities into the identity space. One potential embodiment when relying on neural networks can result in the projection into equality distant positions in a unitary hyper-circle within the identity space. The motion for this approach is that neural networks are often better at identifying directions than specific space locations. These positions are randomized at each computation to avoid the model from becoming biased or memorizing patterns that may not appear during inference time.
Token embeddings:
   For each aₖ=(sₖ, pₖ, oₖ, tₖ)ϵ [symbol] , there are various possible approaches for tokenization:
      One option is to write the tokenization approach as:
         [null_token][null_token][null_token][EOT],
      where [null_token] is a special token leading to position 0 in token embedding space, and [EOT] is a special token to indicate the end of triplet position. This approach may be used for IT infrastructure agnostic models.
      Another option is to write the tokenization approach as:
         [token_id_sk][token_id_pk][token_id_obj][EOT].
      Here, the [token_id_. . . . ] is an expansion of the vocabulary to enable identification of a specific IT infrastructure entity or relationship, therefore enabling the IT infrastructure to memorize behaviors of a particular entity. This may be useful in models dedicated to operating on specific IT infrastructures.
      Identifying all entities and relationships of the network can lead to considerable increase in the vocabulary which may hinder performance. In an embodiment then, one intermediary solution for improving scalability of infrastructure specific LITHIUM technology is to identify only primary, or core, entities. It is noted that, one embodiment does not handle timestamps in the token and operation space. Rather, those timestamps may have their own dimension.
   For each context triple cₖ=(sₖ,pₖ,oₖ)ϵ [symbol] , an embodiment may transform that context triple to the sequence:
      [SU] tokenizer(sₖ) [PR] tokenizer(pₖ) [OBJ] tokenizer(oₖ)
   where [SU], [PR], [OBJ], are respectively special tokens to indicate subject, predicate, object positions and tokenizer is the function mapping natural language to token space. Therefore, entities and relationships in the KG representation of the prime network information flow are encoded similarly to natural language, enabling the model to share common factor of variations whenever relevant for the problem space. It is noted that the tokenizer may return a variable number of tokens even if sₖ,pₖ and oₖ are all composed of a single word, and that sₖ, pₖ and oₖ are not necessarily composed of a single word.
Time subspace: Recall that, as discussed above, information flow tempo is may be particularly important to correctly characterize IT infrastructure data. Thus, an embodiment may employ a dedicated subspace, the time subspace. In its minimal form, this time subspace may comprise a 2D space composed of:
   The delta between the latest activity and the current activity. All triplet information of the activity corresponds to the same delta. While it is possible to gain statistical and computational efficiency by using specific modelling approaches, for simplicity of exposition one possible embodiment may be configured in which the time subspace information is repeated for each activity triplet tokens.
   A categorical variable corresponding to the unit of the delta. Albeit it creates discontinuity in the delta space, we believe that this approach allows to better model the dynamic range of time in different operations. For example, thin granular activities may result in [μs] while coarse granularity requires representing activities ranging from [minute] to [hour].
   To handle special cases not leading to elapsed time, an embodiment may employ a special unit [ignore] and does not propagate errors in predictions made in the delta subspace, so as to avoid biasing the model.
Segment embedding: The idea is to facilitate learning by providing explicit information about the source of information. For example, is it a metadata, context or an activity?, is it natural language, or an operation? Therefore, an embodiment may employ the usage of a learned embedding space to indicate the information source for each case. Although it is applied to solve a different problem and differentiate across different segment types, this approach may be similar to the segment embedding strategy disclosed in reference [4].
Position embedding: is composed of the standard embedding space employed by transformers to determine the position of each information piece in the serialized information flow.

### D.2.3 Information Flow Capillarization

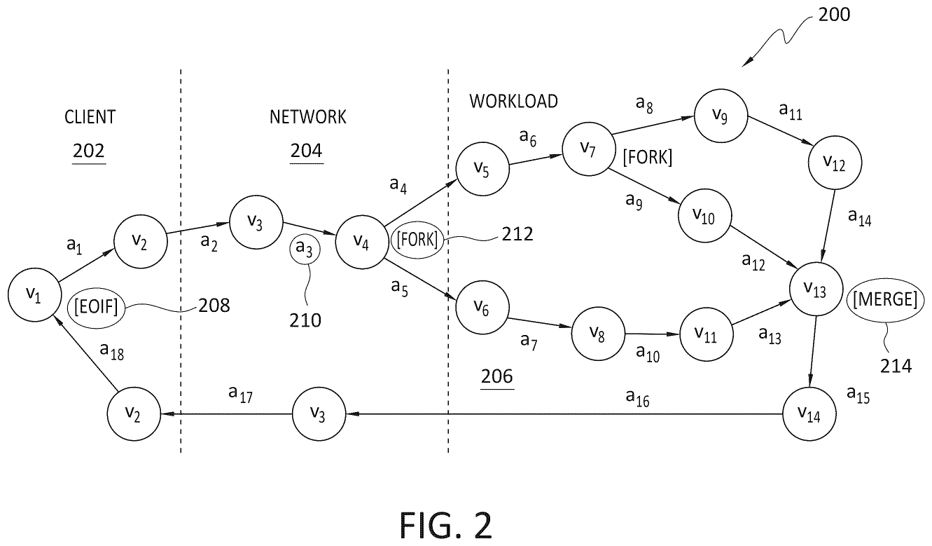

As noted earlier herein, written natural language is single channel in nature, by design. On the other hand, prime network information flows can vary the number of channels arbitrarily, increasing and decreasing the number of channels as required. This process is referred to herein as information flow capillarization process (IFCP), one example of which is disclosed in FIG. 2 at 200. In the example of FIG. 2, the IFCP 200 may involve various entities, including a client 202, network 204, and a workload 206. With reference to the example of FIG. 2, it is noted that the information flow is completed when there is no channel left, which may or may not result in a complete information flow loop as represented below. For instance, and as shown in FIG. 2, [EOIF] 208, indicating ‘end of information flow’ for a channel, could have occurred after a₃ 210 if the request was denied and the access protocol does not include a deny response.

To efficiently derive a general-purpose solution, one embodiment provides a way to serialize information capillarization while still maintaining universal semantic description capabilities. An enhancement of the activity description to make fork and merge operations may be made explicit as follows:
Fork: for each activity a_{fork}—see [FORK]212 for example—being performed by the same subject entity in the prime network involving the same set of core entities and before observing a loop, may be modified in the following way:
   create a temporary fork v_{fork} and add it to [symbol] ;
   split a_{fork}=(sᵢ,pᵢ,oᵢ,tᵢ) into:
      a_{fork,1}=(s₁,fork,id(v_{fork}),tᵢ); and
      a_{fork,2}=(id(v_{fork}),pᵢ,oᵢ,tᵢ); and
   proceed with standard tokenization approach as described earlier herein.
Merge: for each activity a_{merge}—see [MERGE]214 for example—with same object identity oᵢ being performed for the same set of core entities and before oᵢ executes an activity involving this set of core entities, may be modified in the following way:
   Create a temporary merge v_{merge} and add it to [symbol] .
   Split a_{merge}=(sᵢ,pᵢ,oᵢ,tᵢ) into:

$$\begin{matrix}{a}_{merge , 1} = ( {s}_{1} , merge , id ( {v}_{merge} ) , {t}_{i} ) ; and \\ {a}_{merge , 2} = ( id ( {v}_{merge} ) , {p}_{i} , {o}_{i} , {t}_{i} ) ;\end{matrix}$$

Proceed with standard tokenization.
   This approach may enable a general-purpose model, according to one embodiment, to identify exactly when the various operations have occurred.

### D.2.4 Pre-Processing

In one embodiment, some cheap, in terms of time and/or processing required, manipulations may be performed before a data modelling operation to improve computational efficiency without limiting model scalability by increasing data quality. On top of typical character, paragraph, and document deduplication typically performed for natural language pre-processing, see Reference [3], one or more embodiments may operate to mitigate the presence of frivolous information through data deduplication at different granularity levels:
1. Operation deduplication: an embodiment may comprise a replacement of multiple consecutive operations of the same kind by a single operation followed by a sequence ([REPEAT], n) where [REPEAT] is a special token and n is the number of times the operation is observed. The information flow quadruplet can incorporate either the sequence of all timestamps or the range where the operations span. The second case is more appropriated for periodic operations.
2. Loop deduplication: replacing them with a single loop followed by a sequence ([REPEAT], [LOOP], n, t) where [LOOP] is a special token and t can either be a sequence of all timestamps where the loops started or the range where the loop spans.
3. Information flow deduplication: Message Digest Algorithm5 (MD5) can be applied to filter duplicated information flows after their tokenization.
   In an embodiment, these pre-processing algorithms may be used to exemplify potential ways to improve data quality but the scope of this disclosure is not limited to these example. These example embodiments provide ways of mitigating frivolous information in prime network information flow.

### D.3 Data Modeling

The following discussion addresses how, in an embodiment, generative AI learning approaches may be applied to the IT infrastructure information flow as serialized through the approach described earlier herein.

### D.3.1 Predicting Identities and Tempo

Differently from language models which are limited to modeling known vocabulary, LITHIUM technology may be able to efficiently model identities for arbitrary IT infrastructure. An embodiment may use one output head to predict tokens and another to predict identities. The identity head is employed whenever the sequence gets in an activity set position requiring an identity. Generally, this may occur for every four predictions in the information flow activity set: the first three are performed by the identity head. The activity aₖ triplet identities, corresponding to (sₖ,pₖ,oₖ) and the last is performed by the token head but depends on the nature of pₖ, as discussed earlier herein. It is noted that the token head can only sample from a limited number of tokens, typically [EOT] and [EOIF].

To enable precise sampling of identities, the identity head returns the identity with lower cosine distance of output with respect to the identity embedding space. By approaching the problem this way, an embodiment may ensure that the model can always return a valid identity.

However, this approach assumes that the identity to be output is available in the input space. It is not a problem neither for sequence-to-sequence pre-training nor for auto-encoding pre-training. But it requires special handling when considering autoregressive pre-training, as described earlier herein.

A similar challenge applies to predicting information flow tempo. One example embodiment may consider adding another output head that trains the shared network when predicting the information flow tempo.

### D.3.2 Pre-Training

In an embodiment, pre-training provides a way to achieve a general-purpose solution to model IT infrastructure data. The usage of large amounts of high-quality data together with massive computational power and adaptive models enable an embodiment to efficiently capture the structure of the problem space. Generative AI approaches applied to model natural language may provide a foundation for one embodiment. However, there are some nuances to be considered. Following is a discussion of some embodiments considering training decoder-only (autoregressive), encoder-only (autoencoding) or encoder-decoder (sequence-to-sequence) models.

### D.3.2.1 Sequence-to-Sequence Pre-Training

One example of sequence-to-sequence pre-trained is the T5 model from Google. In this approach, the full sequence can be presented to the model. In an embodiment, such approaches may be applied in a straightforward way to the serialized information flow:
span corruption: in this case, a special token [SENTINEL] may be added to a masked part of the serialized information flow, and the model is requested to generate the missing segment auto-regressively; and
it is noted that the approach proposed for autoregressive pre-training discussed above may be applied for sequence-to-sequence pre-training by applying span corruption [SENTINEL] to predict [symbol] , [symbol] in stage 1, and to predict [NEW_ID] identity in stage 3.

### D.3.2.2 Auto-Encoding Pre-Training

The ERNIE 3.0 natural language understanding module from Baidu, and BERT from Google, are examples that use an auto-encoding pre-training approach. Likewise, with respect to sequence-to-sequence pre-training, it is straightforward to adapt standard pre-training methods to the proposed serialization of prime network information flow:
token-aware masking: can be applied universally at any position in the information flow;
sentence reordering: whenever the information flow originates from natural language, it can be applied as in the original method. A similar approach can be applied in the prime network information flow when considering the activity set and request the model to reorder it. Such operation cannot be applied to the context set as its order is irrelevant to the description of the problem space; and
sentence distance: like sentence reordering, but using categorical labeling whether activities are adjacent, nonadjacent but in the same information flow, nonadjacent from two different information flows.

### D.3.2.3 Autoregressive Pre-Training

Autoregressive pre-training is one possible approach to obtain general-purpose models in language modelling. Examples in this family include the OpenAI GPT-3 and GPT-4, and the Anthropic Claude2 model.

Recall from the earlier discussion herein that, in one embodiment, predicting identities may require special handling. This may be important when applying causal information flow modelling. In this approach, the model should not have access to the identity in the information flow context and generate it. However, the generated identity should make sense for the particular IT infrastructure. The model should be able to generalize and generate correct identities despite it not being presented in the training set. It is noted that, as disclosed herein, one example approach to serialize identities is based on randomization to avoid memorization, so that the model cannot resort to implicit knowledge in its weights to predict identities. This implies that causal information modelling cannot predict the correct output using the identity head both because it is not available in the identity space, and it cannot be recorded to the model parameters. Therefore, causal modelling must be adapted to enable predicting identities.

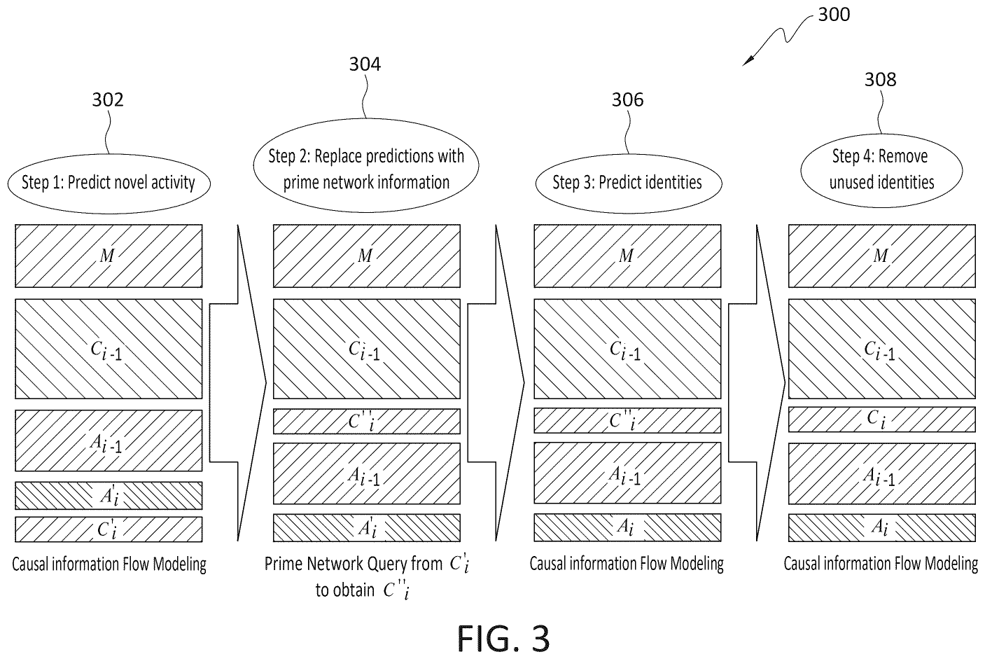

FIG. 3 depicts an example embodiment that comprises a three-stage procedure that provides a solution to this challenge. In particular, FIG. 3 discloses a process 300, according to one embodiment, to predict novel activities in the network with correct identities when performing auto-regressive pre-training of a LITHIUM model. In general, the example method 300 may comprise the operations: predicting 302 novel activity; replacing 304 predictions with prime network information; predicting 306 identities; and, removing 308 any unused identities.

In more detail, the example process 300 of FIG. 3 may proceed as follows:
1. Let [symbol] denote the initial information flow. Also let i denote the index of an activity in [symbol] . The causal information flow modelling can be performed for any index i in parallel just like causal language modelling.
2. Create a truncated information flow [symbol] including aᵢ₋₁ to [symbol] set and add the context only for corresponding to this activity to form the [symbol] .
3. If the algorithm is being executed for [symbol] , then employ causal modelling for the entire [symbol] .
4. Define A′ᵢ as training target by modifying aᵢ identity to a [NEW_ID] token. The [NEW_ID] token is a placeholder to be later replaced by the correct identity.
5. Define C′ᵢ as training target by selecting triplets defining the type of the identity. This enables the model to learn how to specify the type of identity that is being generated.
6. Perform step 1. training using A′ᵢ and C′ᵢ as targets provided of [symbol] . It is noted that this step implies in the generation of several outputs. The process can be parallelized, and each output provide its own alterations to the model parameters, as in standard causal language modelling.
7. In step 2., the model output C′ᵢ is used to query the prime network KG and retrieve the potential identities C″ᵢ. These are added to the information flow. This step is performed during inference time, or at the open loop pre-training stage, if applied.
8. Provided of potential identities in the context serialization, step 3. replaces the [NEW_ID] placeholders. This must be performed sequentially.
9. Any unused identities are removed from the potential identities C″ᵢ set to form the new context Cᵢ.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other byway of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.

Embodiment 1. A method for constructing and pre-training a model of an information technology (IT) infrastructure, comprising: creating a model of the IT infrastructure by: generating a KG (knowledge graph) representation of IT infrastructure data; serializing information flows within the KG to generate serialized information flows; and pre-processing the serialized information flows to improve a quality of the IT infrastructure data relative to a quality of the IT infrastructure data prior to the pre-processing; and pre-training the model, comprising: training the model to capture a structure of both natural language and IT infrastructure flow by predicting, without hallucinations, tokens and identities of the IT infrastructure; providing customizations to enable the model to correctly predict the identities; and pre-training the model with causal modeling when identities are unknown in one of the information flows.

Embodiment 2. The method as recited in any preceding embodiment, wherein the model, after the pre-training, is used to perform cybersecurity analytics in the IT infrastructure.

Embodiment 3. The method as recited in embodiment 2, wherein the cybersecurity analytics are defined in zero-trust architecture.

Embodiment 4. The method as recited in any preceding embodiment, wherein the model, after the pre-training, is used to improve performance of the IT infrastructure.

Embodiment 5. The method as recited in any preceding embodiment, wherein the model, after the pre-training, is operable to represent the IT infrastructure data both in natural language form, and machine readable form.

Embodiment 6. The method as recited in embodiment 5, wherein representation of the IT infrastructure data both in natural language form, and machine readable form, is achieved by tokenization of the KG.

Embodiment 7. The method as recited in any preceding embodiment, wherein the serializing of the information flows is performed using a data serialization framework that is operable to handle capillarized information flows occurring in the IT infrastructure.

Embodiment 8. The method as recited in any preceding embodiment, wherein the serializing of the information flows is performed using a data serialization framework that provides access to implicit context information concerning one or more of the information flows.

Embodiment 9. The method as recited in any preceding embodiment, wherein the serializing of the information flows comprises: adding an identity space to ensure that identities in the IT infrastructure are not memorized by the model; and, using an intrinsic RAG (retrieval augmented generation mechanism) to populate implicit context within the IT infrastructure not present in the information flows.

Embodiment 10. The method as recited in embodiment 9, wherein the serializing of the information flows comprises adding descriptions, to the KG, of join and merge processes occurring in the information flows so as to enable information flow capillarization representation.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

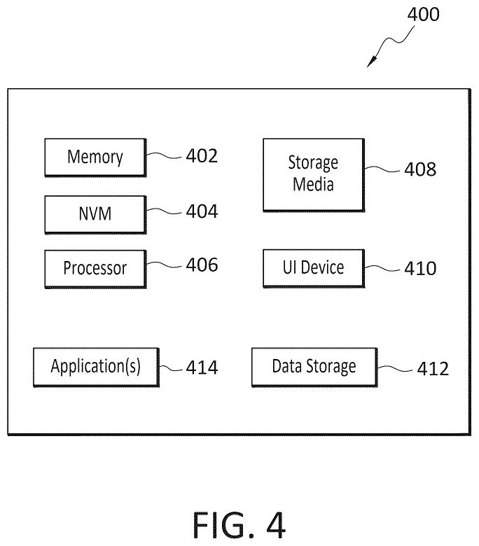

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for constructing and pre-training a model of an information technology (IT) infrastructure, comprising:
creating a model of the IT infrastructure by:
generating a KG (knowledge graph) representation of IT infrastructure data;
serializing information flows within the KG to generate serialized information flows; and
pre-processing the serialized information flows to improve a quality of the IT infrastructure data relative to a quality of the IT infrastructure data prior to the pre-processing; and
pre-training the model, comprising:
training the model to capture a structure of both natural language and IT infrastructure flow by predicting, without hallucinations, tokens and identities of the IT infrastructure;
providing customizations to enable the model to correctly predict the identities; and
pre-training the model with causal modeling when identities are unknown in one of the information flows.

2. The method as recited in claim 1, wherein the model, after the pre-training, is used to perform cybersecurity analytics in the IT infrastructure.

3. The method as recited in claim 2, wherein the cybersecurity analytics are defined in zero-trust architecture.

4. The method as recited in claim 1, wherein the model, after the pre-training, is used to improve performance of the IT infrastructure.

5. The method as recited in claim 1, wherein the model, after the pre-training, is operable to represent the IT infrastructure data both in natural language form, and machine readable form.

6. The method as recited in claim 5, wherein representation of the IT infrastructure data both in natural language form, and machine readable form, is achieved by tokenization of the KG.

7. The method as recited in claim 1, wherein the serializing of the information flows is performed using a data serialization framework that is operable to handle capillarized information flows occurring in the IT infrastructure.

8. The method as recited in claim 1, wherein the serializing of the information flows is performed using a data serialization framework that provides access to implicit context information concerning one or more of the information flows.

9. The method as recited in claim 1, wherein the serializing of the information flows comprises: adding an identity space to ensure that identities in the IT infrastructure are not memorized by the model; and, using an intrinsic RAG (retrieval augmented generation mechanism) to populate implicit context within the IT infrastructure not present in the information flows.

10. The method as recited in claim 9, wherein the serializing of the information flows comprises adding descriptions, to the KG, of join and merge processes occurring in the information flows so as to enable information flow capillarization representation.

11. A non-transitory storage medium having stored therein instructions that are executable by one or more hardware processors to perform operations comprising:
performing a method for constructing and pre-training a model of an information technology (IT) infrastructure, the method comprising:
creating a model of the IT infrastructure by:
generating a KG (knowledge graph) representation of IT infrastructure data;
serializing information flows within the KG to generate serialized information flows; and
pre-processing the serialized information flows to improve a quality of the IT infrastructure data relative to a quality of the IT infrastructure data prior to the pre-processing; and
pre-training the model, comprising:
training the model to capture a structure of both natural language and IT infrastructure flow by predicting, without hallucinations, tokens and identities of the IT infrastructure;
providing customizations to enable the model to correctly predict the identities; and
pre-training the model with causal modeling when identities are unknown in one of the information flows.

12. The non-transitory storage medium as recited in claim 11, wherein the model, after the pre-training, is used to perform cybersecurity analytics in the IT infrastructure.

13. The non-transitory storage medium as recited in claim 12, wherein the cybersecurity analytics are defined in zero-trust architecture.

14. The non-transitory storage medium as recited in claim 11, wherein the model, after the pre-training, is used to improve performance of the IT infrastructure.

15. The non-transitory storage medium as recited in claim 11, wherein the model, after the pre-training, is operable to represent the IT infrastructure data both in natural language form, and machine readable form.

16. The non-transitory storage medium as recited in claim 15, wherein representation of the IT infrastructure data both in natural language form, and machine readable form, is achieved by tokenization of the KG.

17. The non-transitory storage medium as recited in claim 11, wherein the serializing of the information flows is performed using a data serialization framework that is operable to handle capillarized information flows occurring in the IT infrastructure.

18. The non-transitory storage medium as recited in claim 11, wherein the serializing of the information flows is performed using a data serialization framework that provides access to implicit context information concerning one or more of the information flows.

19. The non-transitory storage medium as recited in claim 11, wherein the serializing of the information flows comprises: adding an identity space to ensure that identities in the IT infrastructure are not memorized by the model; and, using an intrinsic RAG (retrieval augmented generation mechanism) to populate implicit context within the IT infrastructure not present in the information flows.

20. The non-transitory storage medium as recited in claim 19, wherein the serializing of the information flows comprises adding descriptions, to the KG, of join and merge processes occurring in the information flows so as to enable information flow capillarization representation.
